(19) United States
(12) Patent Application Publication
(10) Pub. No.: US 2012/0314098 A1
(43) Pub. Date: Dec. 13, 2012

(54) Video Reproducing Apparatus

(75) Inventor: Kazuto Kitagawa, Daito-shi (JP)

(73) Assignee: Funai Electric Co., Ltd.

(21) Appl. No.: 13/490,537

(22) Filed: Jun. 7, 2012

(30) Foreign Application Priority Data
Jun. 13, 2011 (JP) 2011-131053

(51) Int. Cl. H04N 5/228

(52) U.S. Cl. 348/222.1; 348/E05.031

(57) ABSTRACT

A video reproducing apparatus comprises: a memory capable of parallel data transfer in which a program for allowing a SoC to operate and parameters for setting a scaler are stored; and bus switches for connecting the memory to either the SoC or the scaler. In this apparatus, when the scaler is started, the circuit to which the memory is connected is switched to the scaler by the bus switches so that the parameters for setting the scaler, which are stored in the memory, can be transmitted in parallel from the memory to the scaler. Therefore, the parameters for setting the scaler can be transmitted to the scaler at high speeds, as compared to a conventional video reproducing apparatus in which the parameters for setting the scaler are transmitted to the scaler via a control line for I²C communication (for serial data transfer).

### BACKGROUND OF THE INVENTION

1. Field of the Invention

The present invention relates to a video reproducing apparatus comprising a System-on-a-Chip (SoC) and a scaler.

2. Description of the Related Art

A video reproducing apparatus comprising a System-on-a-Chip (SoC) and a scaler is known in the prior art. The SoC is a semiconductor chip equipped with various circuits for realizing major functions of the apparatus itself, including a function to reproduce video signals. The scaler performs scaling, noise reduction, and other image processing for reproduced video signals input from the SoC and outputs the processed video signals to a display. When the scaler is started in this kind of video reproducing apparatus, parameters for setting the scaler are generally transmitted from the SoC side to the scaler side by Inter-Integrated Circuit (I²C) communication, which is a method for serial communication between circuits, so as to set the scaler.

Referring now to FIG. 3, the conventional scaler setting process in the case where the video reproducing apparatus is a BD player is described in detail. As shown in FIG. 3, in the conventional BD player 101 comprising a SoC 102 and a scaler 108, the SoC 102 and the scaler 108 are connected via a data (signal) line L101 for transmission of video signals (digital video signals) and audio signals (digital audio signals) and via a control (signal) line L102 for I²C communication (which is originally a line for transmission of control signals from the SoC 102 to the scaler 108).

Further, a program for allowing the SoC 102 (CPU 103 in it) to operate (SoC control program) is stored in a memory capable of parallel data transfer such as a NAND flash memory 110. When the apparatus is started, this program is read by the SoC 102 and stored in the RAM 105 within the SoC. Then, when the SoC control program has been read by the SoC 102 and the SoC 102 has been started, the SoC 102 transmits to the scaler 108 the parameters for setting the scaler via the above described control line L102 for I²C communication, thus setting the scaler 108.

In the field of optical disc apparatus having a scaler, Japanese Laid-open Patent Publication No. 2008-141322 discloses an apparatus comprising: a first scaler that converts video data at multiple resolutions, which are recorded on an optical disc, into video data at a specific resolution; and a second scaler that converts the video data converted to the specific resolution into video data at a designated resolution. Even when video images at different resolutions are included in a sequence of video images recorded on an optical disc, the apparatus can convert the resolutions over a wide range without interrupting the video sequence.

### BRIEF SUMMARY OF THE INVENTION

However, the video reproducing apparatus described referring to FIG. 3, which transmits to the scaler the parameters for setting the scaler via the control line for I²C communication (for serial data transfer), has the following problem. Since the data amount of parameters for setting the scaler is too large for serial data transfer, it takes time before the scaler has been set so that it can output video signals (output images) to the display.

The invention described in Japanese Laid-open Patent Publication No. 2008-141322 cannot solve the above described problem.

An object of the present invention is to provide a video reproducing apparatus that can transmit, to a scaler, parameters for setting the scaler at high speeds so as to reduce the time required for setting the scaler, as compared to the conventional video reproducing apparatus that transmits to the scaler the parameters for setting the scaler via the control line for I²C communication (for serial data transfer).

According to an aspect of the present invention, a video reproducing apparatus comprises: a System-on-a-Chip that is a semiconductor chip equipped with various circuits for realizing major functions of the apparatus, including a function to reproduce video signals; a scaler that performs, for reproduced video signals input from the System-on-a-Chip, image processing including scaling for converting the reproduced video signals into video signals corresponding to pixel number of a screen on display means, and outputs processed video signals to the display means; a memory which is capable of parallel data transfer, and which stores a program for allowing the System-on-a-Chip to operate and a parameter for setting the scaler; and memory connection switching means for switching the circuit to which the memory is connected between the System-on-a-Chip and the scaler.

With this configuration, when the scaler is started, the circuit to which the memory is connected is switched to the scaler by the memory connection switching means so that parameters for setting the scaler, which are stored in the memory, can be transmitted in parallel from the memory to the scaler. Therefore, the parameters for setting the scaler can be transmitted to the scaler at high speeds, as compared to the conventional video reproducing apparatus in which the parameters for setting the scaler are transmitted to the scaler via the control line for I²C communication (for serial data transfer). This can reduce the time required for setting the scaler, thus reducing the time before video signals can be output to a display at the time of startup of the apparatus. Further, by providing the memory connection switching means for switching the circuit to which the memory is connected between the System-on-a-Chip and the scaler, the memory for storing the program for allowing the System-on-a-Chip to operate can be also used as a memory for storing the parameters for setting the scaler. This can reduce the manufacturing cost of the apparatus as a whole, as compared to an apparatus provided with a dedicated memory for storing parameters for setting the scaler.

Preferably, the memory is a flash memory capable of parallel data transfer. By using the flash memory capable of parallel data transfer as the memory for storing the parameters for setting the scaler, the above described effect can be achieved appropriately.

More preferably, the memory is a NAND flash memory capable of parallel data transfer. By using the NAND flash memory, which is inexpensive and capable of parallel data transfer, as the memory for storing the parameters for setting the scaler, the manufacturing cost of the apparatus as a whole can be reduced in addition to the effect described above.

Preferably, the memory connection switching means has a bus switch comprising a semiconductor device. By using the bus switch comprising a semiconductor device as the memory connection switching means, the circuit to which the memory is connected can be switched by simple control.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram of a BD player that is a video reproducing apparatus according to a first embodiment of the present invention;

FIG. 2 is an electrical block diagram of a TV receiver that is a video reproducing apparatus according to a second embodiment of the present invention; and

FIG. 3 is an electrical block diagram of a conventional BD player comprising a SoC and a scaler;

### DETAILED DESCRIPTION OF THE INVENTION

Referring now to the accompanying drawings, embodiments of the present invention are described. It is to be noted that the following description of preferred embodiments of the present invention has been presented for purposes of illustration and description, and is not intended to be exhaustive or to limit the present invention to the precise form disclosed.

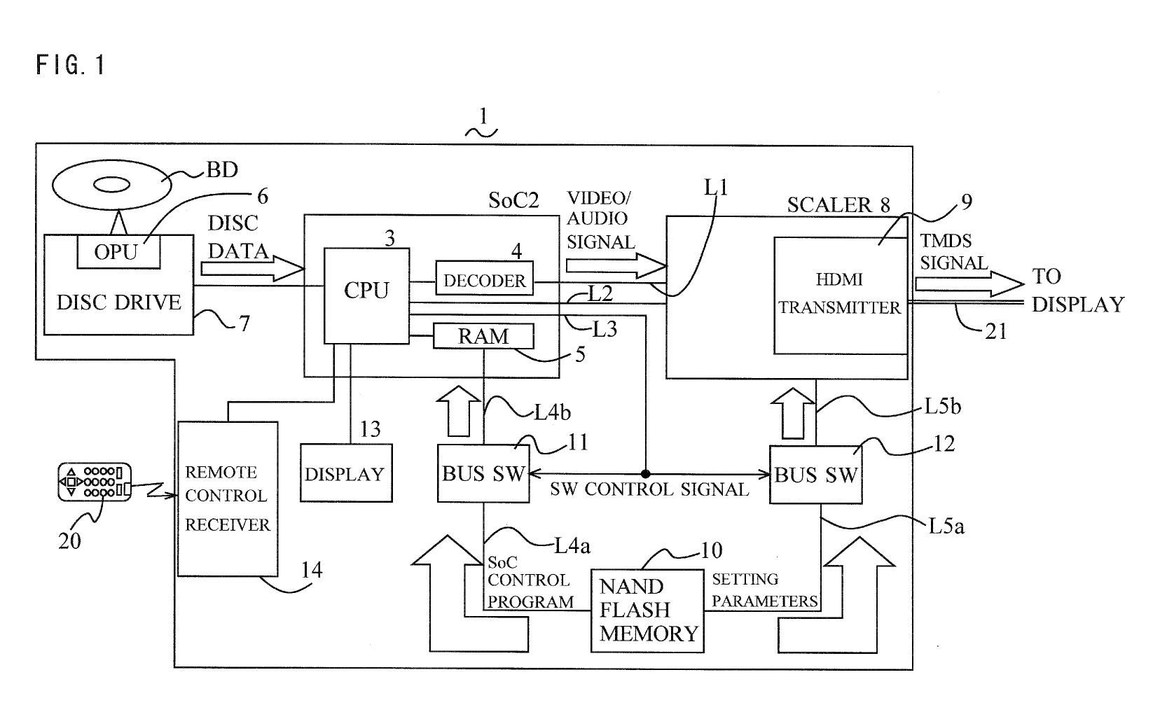

In a first embodiment, a video reproducing apparatus according to the present invention is a Blu-ray Disc (BD) player. FIG. 1 shows the BD player 1 that is the video reproducing apparatus according to the first embodiment. The BD player 1 comprises a disc drive 7 having an optical pickup unit (hereinafter referred to as “OPU”) 6, which emits a light beam onto a Blu-ray Disc (BD) and converts the reflected light as read-out light into electrical signals. By driving the OPU 6 with a BD, the disc drive 7 reads data recorded on the BD (Disc data in FIG. 1).

The BD player 1 further comprises a System-on-a-Chip (SoC) 2 and a scaler 8. The SoC 2 is a semiconductor chip equipped with various circuits for realizing major functions of the player, including a function to reproduce video signals. The scaler 8 performs, for reproduced video signals input from the SoC 2, scaling for converting the reproduced video signals into video signals corresponding to pixel number of the screen on a display such as a television receiver (hereinafter referred to as “TV receiver”), noise reduction, and other image processing, and then outputs the processed video signals (and audio signals input from the SoC 2) to the display.

The SoC 2 comprises a CPU 3 that controls each component in the player, a decoder 4 that decodes data such as video and audio read by the disc drive 7 to produce video signals (digital video signals) and audio signals (digital audio signals), and a Random Access Memory (RAM) 5 in which a SoC control program (program for allowing the SoC 2 (CPU 3 in it) to operate) and various kinds of data are loaded when the player is started.

The scaler 8 has a High-Definition Multimedia Interface (HDMI) transmitter 9 that is an interface circuit for transmitting video signals and other signals via HDMI communication. By using the HDMI transmitter 9, the scaler 8 outputs video signals after the image processing such as scaling and noise reduction as well as audio signals input from the SoC 2 in the form of TMDS differential signals via an HDMI cable 21 to a display such as a TV receiver.

The SoC 2 and the scaler 8 are connected via a data signal line L1 for transmission of video signals (digital video signals) and audio signals (digital audio signals) and via a control signal line L2 for I²C communication that is a line for transmission of control signals from the SoC 2 to the scaler 8.

The BD player 1 further has: a NAND flash memory (hereinafter referred to simply as “memory”) 10 capable of parallel data transfer in which the above described SoC control program and parameters for setting the scaler 8 (scaler side setting parameters) are stored; and bus switches (bus SWs) 11 and 12 (memory connection switching means) for connecting the memory 10 to either the SoC 2 or the scaler 8.

Each of the bus SWs 11 and 12 comprises a semiconductor device such as a FET. One of the bus SWs is a normally-on switch while the other bus SW is a normally-off switch. In this embodiment, the bus SW 11 provided on the line connecting between the memory 10 and the SoC 2 (RAM 5 in it) is a normally-on switch while the bus SW 12 provided on the line connecting between the memory 10 and the scaler 8 (storage element not shown in it) is a normally-off switch. Thus, when SW control signals output from the CPU 3 in the SoC 2 via a SW control signal line L3 to the bus SWs 11 and 12 are Low, the bus SW 11 is turned on so that the circuit to which the memory 10 is connected is switched to the SoC 2 (RAM 5 in it). When SW control signals are High, the bus SW 12 is turned on so that the circuit to which the memory 10 is connected is switched to the scaler 8 (storage element not shown in it).

For example, a normally-on semiconductor switching device such as a junction type FET can be used as the normally-on bus SW 11. A normally-off semiconductor switching device such as a MOSFET can be used as the normally-off bus SW12.

The lines L4a and L4b connecting between the memory 10 and the SoC 2 (RAM 5 in it) via the bus SW 11 are shown as a single line in FIG. 1 for simplicity. However, each of the lines comprises multiple lines so as to enable parallel data transfer from the memory 10 to the SoC 2. Each of the lines L5a and L5b connecting between the memory 10 and the scaler 8 (storage element not shown in it) via the bus SW 12 also comprises multiple lines so as to enable parallel data transfer from the memory 10 to the scaler 8.

The BD player 1 further comprises a display 13 for displaying various messages and other information and a remote control receiver 14 for receiving remote control signals. Further, the BD player 1 has a remote control 20 that transmits remote control signals in response to a user action.

When the BD player 1 as configured above is started, the SW control signals, which are output from the CPU 3 in the SoC 2 via the SW control signal line L3 to the bus SWs 11 and 12, are Low. Thus, the bus SW 11 is on while the bus SW 12 is off. Therefore, the memory 10 and the SoC 2 (RAM 5 in it) are connected via the bus SW 11 so that the SoC control program is loaded from the memory 10 into the RAM 5 within the SoC 2. When the SoC control program has been loaded, the CPU 3 in the SoC 2 turns the SW control signals, which are output to the bus SWs 11 and 12, to High so as to run the scaler 8, in accordance with the SoC control program. Thereby, the bus SW 11 is turned off while the bus SW 12 is turned on. Thus, the memory 10 and the scaler 8 (storage element not shown in it) are connected via the bus SW 12, and based on a request from the scaler 8, the parameters for setting the scaler 8 that are stored in the memory 10 are transmitted in parallel to the scaler 8 and stored in the scaler 8 (storage element not shown in it).

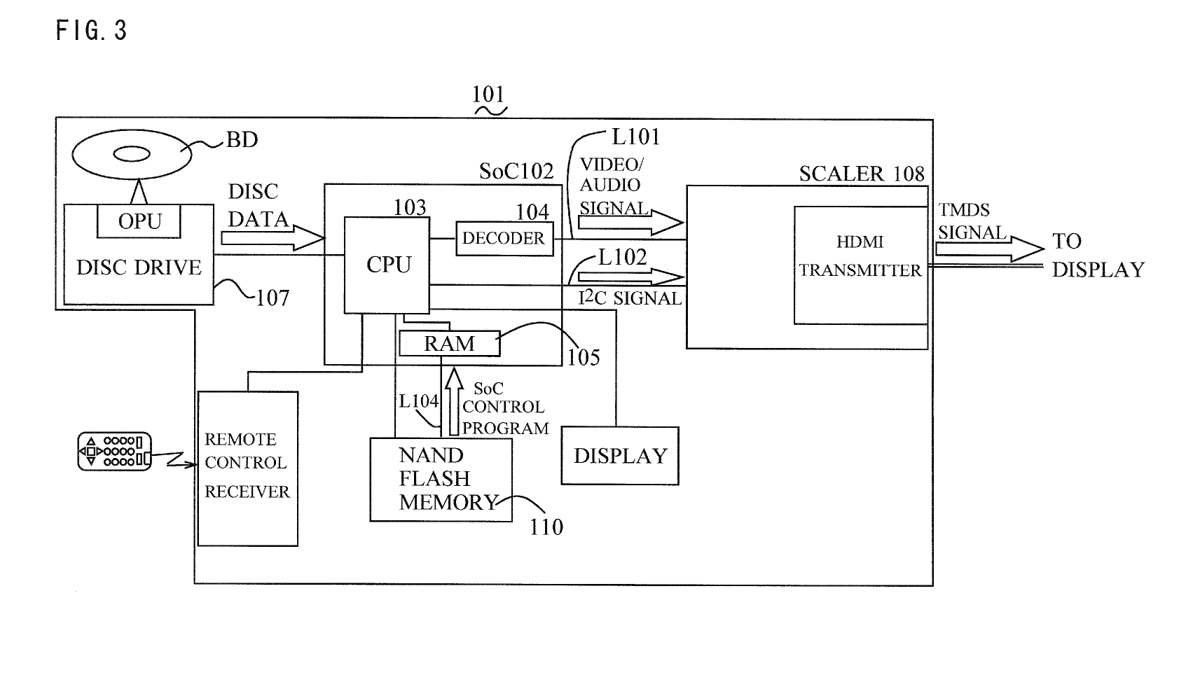

When the scaler 8 is started, the scaler 8 operates not as a slave of the SoC 2 but as a master. However, after the scaler 8 has been started, it operates as a slave of the SoC 2 based on control signals transmitted from the SoC 2 via the control line L2 for I²C communication, like that in the conventional BD player 101 shown in FIG. 3.

According to the BD player 1 of this embodiment as described above, when the scaler 8 is started, the circuit to which the memory 10 is connected is switched to the scaler 8 by the bus SWs 11 and 12 so that the parameters for setting the scaler, which are stored in the memory 10, can be transmitted in parallel from the memory 10 to the scaler 8. Therefore, the parameters for setting the scaler can be transmitted to the scaler 8 at high speeds, as compared to the conventional video reproducing apparatus in which the parameters for setting the scaler are transmitted to the scaler via the control line for I²C communication (for serial data transfer). This can reduce the time required for setting the scaler 8, thus reducing the time before video signals can be output (images can be output) to a display such as a TV receiver at the time of startup of the apparatus.

By providing the bus SWs 11 and 12 for switching the circuit to which the memory 10 is connected between the SoC 2 and the scaler 8, the memory 10 for storing the SoC control program can be also used as a memory for storing the parameters for setting the scaler. This can reduce the manufacturing cost of the apparatus as a whole, as compared to an apparatus provided with a dedicated memory for storing parameters for setting the scaler.

Further, according to the BD player 1 of this embodiment, the NAND flash memory, which is inexpensive and capable of parallel data transfer, is used as the memory 10 for storing the parameters for setting the scaler 8. This can reduce the manufacturing cost of the apparatus as a whole.

Furthermore, according to the BD player 1 of this embodiment, the bus SWs 11 and 12 each comprising a semiconductor device such as a FET are used as memory connection switching means in claims. Thereby, the circuit to which the memory 10 is connected can be switched by simple control.

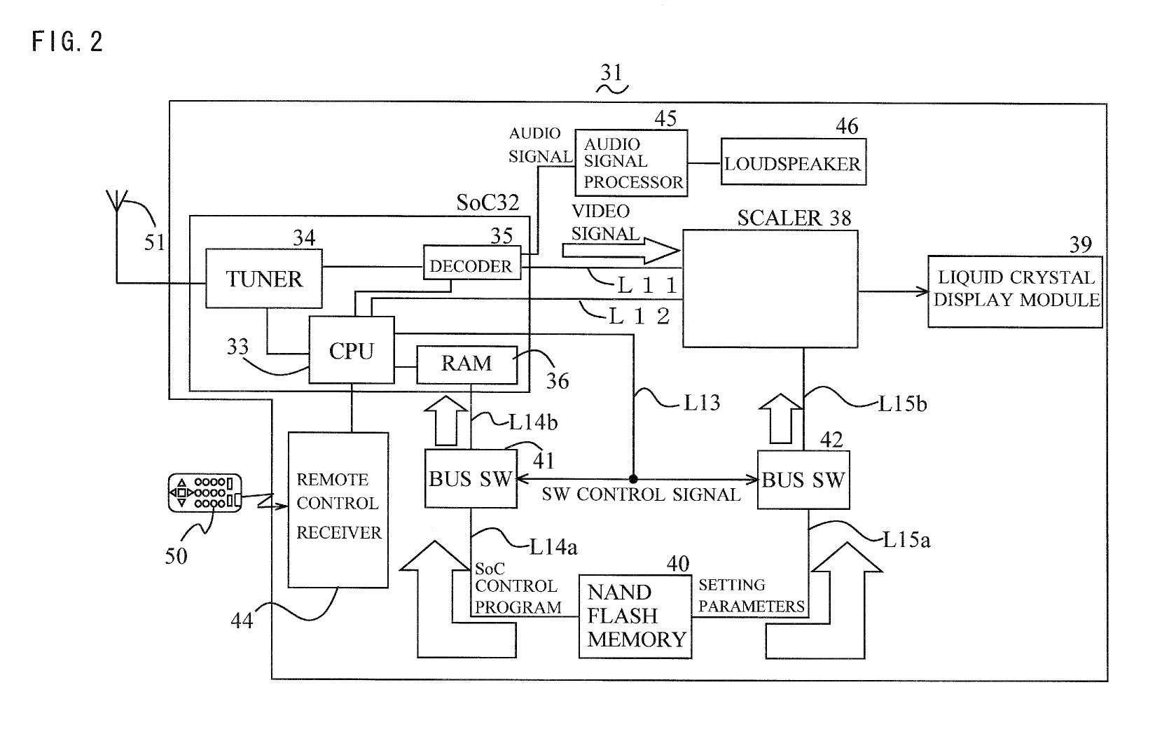

Referring now to FIG. 2, a television receiver (hereinafter referred to as “TV receiver”) 31 that is a video reproducing apparatus according to a second embodiment of the present invention is described. In this example, the TV receiver 31 is a liquid crystal display television capable of outputting video and audio of digital television broadcasts. As shown in FIG. 2, the TV receiver 31 comprises a SoC 32 and a scaler 38. The SoC 32 is a semiconductor chip equipped with various circuits for realizing major functions of the receiver, including a function to reproduce video signals. The scaler 38 performs, for reproduced video signals input from the SoC 32, scaling for converting the reproduced video signals into video signals corresponding to pixel number of the screen of a liquid crystal panel on a liquid crystal display module 39, noise reduction, and other image processing, and then outputs the processed video signals to the liquid crystal display module 39.

The SoC 32 comprises a CPU 33 that controls each component in the receiver, a tuner 34 for receiving digital television broadcast signals (transport streams) via an antenna 51, a decoder 35 that decodes packets in transport streams received by the tuner 34 to thereby produce video signals (digital video signals), audio signals (digital audio signals), and data signals, and a Random Access Memory (RAM) 36 in which a SoC control program (program for allowing the SoC 32 (CPU 33 in it) to operate) and various kinds of data are loaded when the receiver is started.

The SoC 32 and the scaler 38 are connected via a data signal line L11 for transmission of video signals, audio signals, and data signals described above and via a control signal line L12 for I²C communication that is a line for transmission of control signals from the SoC 32 to the scaler 38.

The TV receiver 31 further comprises: a memory 40 that is a NAND flash memory similar to the above described memory 10; a bus SW 41 that is a normally-on switch similar to the above described bus SW 11; a bus SW 42 that is a normally-off switch similar to the above described bus SW 12; and a SW control signal line L13 for outputting SW control signals from the CPU 33 in the SoC 32 to the bus SWs 41 and 42 (similar to the above described SW control signal line L3). When SW control signals output from the CPU 33 in the SoC 32 via the SW control signal line L13 to the bus SWs 41 and 42 are Low, the bus SW 41 is turned on so that the circuit to which the memory 40 is connected is switched to the SoC 32 (RAM 36 in it). When SW control signals are High, the bus SW 42 is turned on so that the circuit to which the memory 40 is connected is switched to the scaler 38 (storage element not shown in it).

The TV receiver 31 further comprises not only lines L14a and L14b connecting between the memory 40 and the SoC 32 (RAM 36 in it) via the bus SW 41 but also lines L15a and L15b connecting between the memory 40 and the scaler 38 (storage element not shown in it) via the bus SW 42. Each of the lines L14a, L14b, L15a, and L15b comprises multiple lines so as to enable parallel data transfer from the memory 40 to the SoC 32 or the scaler 38.

The TV receiver 31 further comprises: the liquid crystal display module 39 for displaying images based on processed video signals output from the scaler 38, an audio signal processor 45 that amplifies audio signals (digital audio signals) input from the decoder 35 in the SoC 32 and converts the digital signals to analog signals; and a loudspeaker 46 that outputs audio based on analog audio signals received from the audio signal processor 45. The liquid crystal display module 39 consists mainly of the liquid crystal panel, a driving printed circuit board, and a backlight.

Further, the TV receiver 31 comprises a remote control receiver 44 for receiving remote control signals and a remote control 50 that transmits remote control signals in response to a user action.

When the TV receiver 31 as configured above is started, SW control signals, which are output from the CPU 33 in the SoC 32 via the SW control signal line L13 to the bus SWs 41 and 42, are Low. Thus, the bus SW 41 is on while the bus SW 42 is off. Therefore, the memory 40 and the SoC 32 (RAM 36 in it) are connected via the bus SW 41 so that the SoC control program is loaded from the memory 40 into the RAM 36 within the SoC 32. When the SoC control program has been loaded, the CPU 33 in the SoC 32 turns SW control signals, which are output to the bus SWs 41 and 42, to High so as to run the scaler 38, in accordance with the SoC control program. Thereby, the bus SW 41 is turned off while the bus SW 42 is turned on. Thus, the memory 40 and the scaler 38 (storage element not shown in it) are connected via the bus SW 42, and based on a request from the scaler 38, parameters for setting the scaler 38 that are stored in the memory 40 are transmitted in parallel to the scaler 38 and stored in the scaler 38 (storage element not shown in it).

When the scaler 38 is started, the scaler 38 operates not as a slave of the SoC 32 but as a master. However, after the scaler 38 has been started, it operates as a slave of the SoC 32 based on control signals transmitted from the SoC 32 via the control line L12 for I²C communication, like that in the conventional BD player 101 shown in FIG. 3.

According to the TV receiver 31 of the second embodiment as described above, when the scaler 38 is started, the circuit to which the memory 40 is connected is switched to the scaler 38 by the bus SWs 41 and 42 so that the parameters for setting the scaler, which are stored in the memory 40, can be transmitted in parallel from the memory 40 to the scaler 38. Therefore, the parameters for setting the scaler can be transmitted to the scaler 38 at high speeds, as compared to the conventional video reproducing apparatus in which the parameters for setting the scaler are transmitted to the scaler via the control line for I²C communication (for serial data transfer). This can reduce the time required for setting the scaler 38, thus reducing the time before video signals can be output (images can be output) to the display of the liquid crystal panel on the liquid crystal display module 39 at the time of startup of the receiver.

By providing the bus SWs 41 and 42 for connecting the memory 40 to either the SoC 32 or the scaler 38, the memory 40 for storing the SoC control program can be also used as a memory for storing the parameters for setting the scaler. This can reduce the manufacturing cost of the apparatus as a whole, as compared to an apparatus provided with a dedicated memory for storing parameters for setting the scaler.

Further, according to the TV receiver 31 of this embodiment, the NAND flash memory, which is inexpensive and capable of parallel data transfer, is used as the memory 40 for storing the parameters for setting the scaler 38. This can reduce the manufacturing cost of the apparatus as a whole.

Furthermore, according to the TV receiver 31 of this embodiment, the bus SWs 41 and 42 each comprising a semiconductor device such as a FET are used as memory connection switching means in claims. Thereby, the circuit to which the memory 40 is connected can be switched by simple control.

The present invention has been described above using presently preferred embodiments, but those skilled in the art will appreciate that various modifications are possible. For example, in the first and second embodiments described above, the present invention is applied to the BD player and the TV receiver, respectively. The present invention may be also applied to other video reproducing apparatus such as a hard disk recorder, a DVD player, a DVD recorder, a BD recorder, and the like. Further, in the first or second embodiment described above, a NAND flash memory is used as the memory 10 or 40 in which the parameters for setting the scaler 8 or 38 are stored. The memory in which the parameters for setting the scaler are stored is not limited to a NAND flash memory but may be another kind of memory capable of parallel data transfer.

This application is based on Japanese patent application No. 2011-131053 filed Jun. 13, 2011, the contents of which are hereby incorporated by reference.

1. A video reproducing apparatus comprising:
a System-on-a-Chip that is a semiconductor chip equipped with various circuits for realizing major functions of the apparatus, including a function to reproduce video signals;
a scaler that performs, for reproduced video signals input from the System-on-a-Chip, image processing including scaling for converting the reproduced video signals into video signals corresponding to pixel number of a screen on display means, and outputs processed video signals to the display means;
a memory which is capable of parallel data transfer, and which stores a program for allowing the System-on-a-Chip to operate and a parameter for setting the scaler; and
memory connection switching means for switching the circuit to which the memory is connected between the System-on-a-Chip and the scaler.

2. The video reproducing apparatus according to claim 1, wherein the memory is a flash memory capable of parallel data transfer.

3. The video reproducing apparatus according to claim 2, wherein the memory is a NAND flash memory capable of parallel data transfer.

4. The video reproducing apparatus according to claim 3, wherein the memory connection switching means has a bus switch comprising a semiconductor device.

5. The video reproducing apparatus according to claim 2, wherein the memory connection switching means has a bus switch comprising a semiconductor device.

6. The video reproducing apparatus according to claim 1, wherein the memory connection switching means has a bus switch comprising a semiconductor device.
